(19) United States
(12) Patent Application Publication
(10) Pub. No.: US 2019/0180376 A1
(43) Pub. Date: Jun. 13, 2019

(54) Financial Correlation Prediction System and the Method Thereof

(71) Applicant: Seth Haoting Huang, Taipei City (TW)

(72) Inventors: Seth Haoting Huang, Taipei City (TW); Rachid Ait Seddik, Taipei City (TW)

(21) Appl. No.: 16/216,000

(22) Filed: Dec. 11, 2018

Related U.S. Application Data
(60) Provisional application No. 62/597,593, filed on Dec. 12, 2017.

(51) Int. Cl. G06Q 40/06; G06N 3/08

(52) U.S. Cl. CPC G06Q 40/06; G06N 3/08

(57) ABSTRACT

This invention discloses a financial correlation prediction system and the method thereof. The mentioned financial correlation prediction system and the method can use multi-layer perception (deep neural network) and artificial neural network model structure to generate more accurate correlation predictions of financial instruments. According to this invention, financial institutions can efficiently build portfolios which consider increasing/decreasing correlations among financial instruments.

### BACKGROUND OF THE INVENTION

### 1. Field of the Invention

The present invention is generally related to a financial correlation prediction system and the method thereof, and more particularly to a financial correlation prediction system and the method thereof with artificial intelligence.

### 2. Description of the Prior Art

Financial instruments' prices and volumes are interrelated with each other. They are to a large degree also connected to the entire market. When constructing large portfolios, given the pre-selected instruments, an asset manager is tasked to construct the portfolio to minimize the inter-correlation among financial instruments. This is a critical step to control the overall portfolio risk because the random movements of financial instruments, if uncorrelated, can cancel each other out, provide better diversification effect and protect investors. However, the method by which majority of fund managers construct the mean-variance portfolio has not evolved for decades. Typically, they would use past-year historical volatility and historical covariances/correlations under the assumption that these attributes will be stationary in the next investment period.

In view of the above matters, developing a novel financial correlation prediction system and the method thereof with artificial intelligence having the advantage of providing forward correlation prediction closer to the evolving, underlying distribution of the market is still an important task for the industry.

### SUMMARY OF THE INVENTION

In light of the above background, in order to fulfill the requirements of the industry, the present invention provides a novel financial correlation prediction system and the method thereof having the advantage of accurately forward correlation predictions closer to the evolving, underlying distribution of the market.

One objective of the present invention is to provide a financial correlation prediction system and the method thereof to generate accurately forward correlation predictions of financial instruments among at least two target products through employing artificial intelligence model(s) to produce the future correlation predictions.

Another objective of the present invention is to provide a financial correlation prediction system and the method thereof to generate future correlation predictions with accurate result closer to the evolving, underlying distribution of the market through the future correlation prediction of financial instrument and market indicator.

Still another object of this present invention is to provide a financial correlation prediction system and the method thereof to generate more accurately future correlation predictions for financial instrument risk forecast through generating future correlation prediction of financial instruments from a plurality of artificial intelligence models past at least one back-testing and parameter tweaking.

Accordingly, the present invention discloses a financial correlation prediction system and the method thereof. The mentioned financial correlation prediction method, for a financial correlation prediction system with artificial intelligence, comprises the process of collecting paired data of financial instrument and related market indicator and building data repository of the paired data with paired data importing unit, building and training a plurality of artificial intelligence models with model importing unit, testing and back-testing the mentioned artificial intelligence models with model filtering unit, using the artificial intelligence models past back-testing for generating future correlation prediction of financial instrument and the related market indicator with future correlation prediction generating unit, and calculating the future correlation prediction of financial instrument and the related market indicator for generating future correlation prediction between financial instruments with calculating unit. In one preferred example of this specification, in the mentioned financial correlation prediction system and the method thereof, recurrent neural network (RNN) can be used to build a plurality of artificial intelligence models from historical paired data of financial instrument and the related market indicator. After performing testing and at least one back-testing, at least one best artificial intelligence model is filtered out wherein the mentioned best artificial intelligence model is at least one artificial intelligence model close to the correlation of the financial instrument and the related market indicator. The mentioned at least one best artificial intelligence model can be used to calculating for generating the future correlation prediction of financial instruments. According to this specification, financial institution/investor can efficiently build portfolios which consider the increasing/decreasing correlations among financial instruments and construct a more effective portfolio.

### BRIEF DESCRIPTION OF THE DRAWINGS

The present disclosure can be described by the embodiments given below. It is understood, however, that the embodiments below are not necessarily limitations to the present disclosure, but are used to a typical implementation of the invention.

FIG. 1 shows a financial correlation prediction system of this invention;

FIGS. 2A and 2B show a flowchart of a financial correlation prediction method of this invention;

FIG. 3 shows a financial correlation prediction system of one example of this invention;

FIGS. 4A and 4B show a financial correlation prediction method of one example of this invention;

FIGS. 5A to 5C show the flowchart of one example from building artificial intelligence models to generating correlation prediction of financial instrument A and Nasdaq Composite Index in FIGS. 4A and 4B; and

FIG. 6 shows a cumulative returns graph of a portfolio of the financial correlation prediction system of this specification and passive market benchmark/S&P500.

### DESCRIPTION OF THE PREFERRED EMBODIMENTS

What probed into the invention is a financial correlation prediction system and the method thereof. Detailed descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater details in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

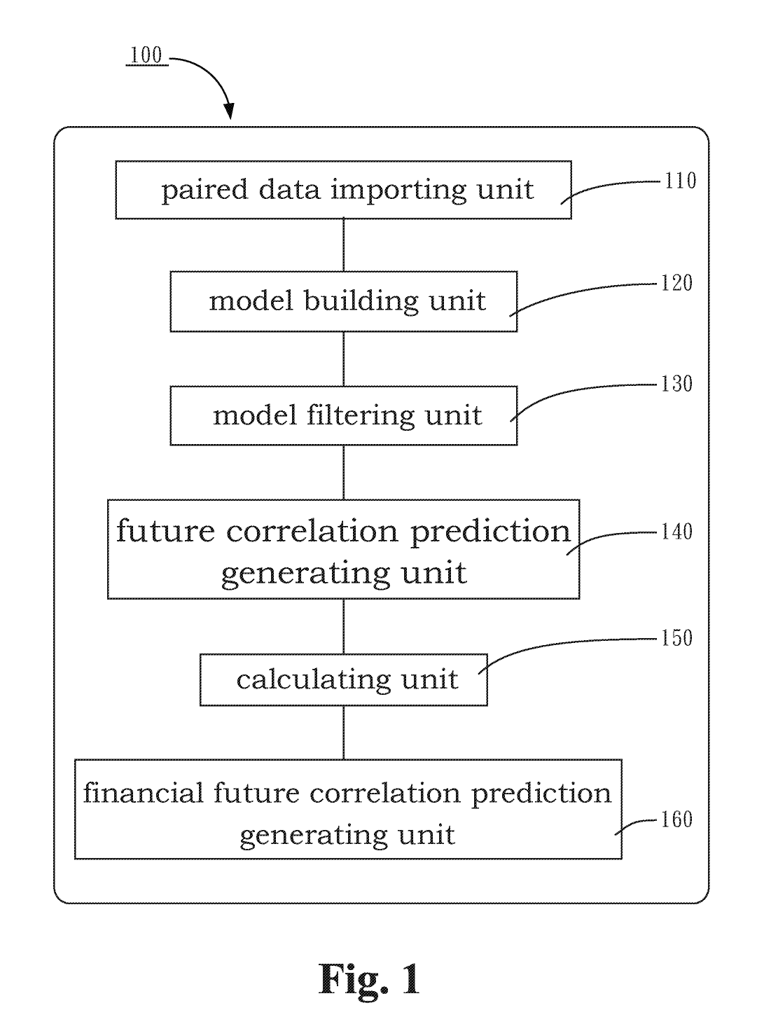

One preferred embodiment according to this specification discloses a financial correlation prediction system. FIG. 1 shows a financial correlation prediction system of this embodiment. Referred to FIG. 1, the mentioned financial correlation prediction system 100 comprises a paired data paired importing unit 110, a model building unit 120, a model filtering unit 130, a future correlation prediction generating unit 140, a calculating unit 150, and a financial future correlation prediction generating unit 160.

According to this embodiment, the paired data importing unit 110 is employed for collecting paired data and building a data repository based on the paired data. The mentioned paired data is the paired data of financial instruments and market indicators. In one preferred example of this embodiment, the mentioned financial instrument can be stock, bond, currency, Futures, or other financial goods known by the one skilled in the art. The mentioned market indicator can be Dow Jones Industrial Average, S&P 500 Index, Nasdaq Composite, MSCI Emerging Markets Index, SSE Composite Index, Bond Index, US Dollar Index, Currency Exchange Rate, Futures Index, Market Sentiment Indicator, Inventor Sentiment Indicator, Purchase Management Index, Gross Domestic Product Index, or other financial indicators known by the one skilled in the art. According to this embodiment, the paired data in the data repository is processed into a unified format to be used for training. And, the features of the paired data are extracted by the paired data importing unit 110, and the features of the paired data can be saved in the mentioned data repository. In one preferred example of this embodiment, the paired data is collecting from multiple sources selected from one or the combination of the group consisted of: sentiment indicators, adjusted historical data, fundamental data, macro data, live feeds, financial reports, social media data, and satellite images. Each of these paired data in the data categories should be maintained up to date and clear of different types of biases. In one preferred example of this embodiment, the relational databases could be used for storage at the paired data importing unit 110.

The model building unit 120 is employed to build a plurality of artificial intelligence models based on the features of the paired data in the data repository in the paired data importing unit 110. The mentioned artificial intelligence models can be constructed from one of the group consisted of: RNN (recurrent neural networks), LSTM (long-short term memory), feed forward networks, CNN (convolutional neural networks), and other artificial neural networks known by the one skilled in the art. In one preferred example of this embodiment, the mentioned features are selected from one or the combination of the group consisted of: price movements, covariances, and product characteristics. In one preferred example of this embodiment, the output of the artificial intelligence models is a time series of observations. In one preferred example of this embodiment, the output of the artificial intelligence models can be sliced into training, validation, and testing data for the artificial intelligence models. In one preferred example of this embodiment, the mentioned artificial intelligence models can also be trained in the model building unit 120. The mentioned artificial intelligence models are trained with the data with unified format from the paired data importing unit 110. The mentioned artificial intelligence models can be trained by the methodologies selected from at least one of the group consisted of: Adam Optimization Algorithm, back propagation, and other techniques/methodologies known by the one skilled in the art.

The model filtering unit 130 is employed for filtering the artificial intelligence models in the model building unit 120. In the model filtering unit 130, the mentioned artificial intelligence models are tested with multiple techniques and methodologies. In one preferred example of this embodiment, paired data in new time period can be used for testing the artificial intelligence models in the mentioned testing, wherein the paired data in new time period is different from those paired data employed for building the artificial intelligence models. Those artificial intelligence models wherein generate worst testing results in the mentioned testing are filtered out and deleted. In one preferred example of this embodiment, parameter tweaking is performed on those artificial intelligence models past the mentioned testing. The parameters of those artificial intelligence models past the mentioned testing are tweaked according to the mentioned testing result of those artificial intelligence models past the mentioned testing. In one preferred example of this embodiment, the parameter tweaking further comprises hyper parameter adjusting, if necessary, wherein the hyper parameters of those artificial intelligence models past the mentioned testing are adjusted according to the mentioned testing result of those artificial intelligence models past the mentioned testing in order to yield better accuracy in the testing results. After tweaking parameters/and adjusting hyper parameters, at least one back-testing is performed on the artificial intelligence models with new testing paired data. After each back-testing, the artificial intelligence models generating worst back-testing results are deleted, and the parameters tweaking and the hyper parameters adjusting are implemented on the artificial intelligence models past the back-testing according to the mentioned back-testing result of those artificial intelligence models past the mentioned back-testing. After back-testing, the artificial intelligence models past the mentioned back-testing and parameter tweaking/and hyper parameters adjusting are saved in the model filtering unit 130. In one preferred example of this embodiment, only recent at least one artificial intelligence models past the back-testing and parameter tweaking/and hyper parameters adjusting are kept in the model filtering unit 130, and the older artificial intelligence models past the back-testing and parameter tweaking/and hyper parameters adjusting are periodically removed from the model filtering unit 130.

In the future correlation prediction generating unit 140, the artificial intelligence models past the mentioned back-testing and parameter tweaking/and hyper parameters adjusting saved in the model filtering unit 130 are reloaded and used for generating the future correlation prediction between financial instrument and market indicator, wherein the mentioned financial instrument and market indicator are used to construct the paired data. The mentioned future correlation prediction can be correlative coefficient, covariance, or other format known by the one skilled in the art.

The future correlation prediction generated by the mentioned future correlation prediction generating unit 140 is going to be transferred to the calculating unit 150. In the calculating unit 150, the future correlation prediction between financial instrument and market indicator is calculated, and the calculating result is going to be transferred to the financial future correlation prediction generating unit 160. In the financial future correlation prediction generating unit 160, the calculating results from the calculating unit 150 can be used to generate the requested financial future correlation prediction between financial instruments according to the input request(s).

In one preferred example of this embodiment, the calculating unit 150 can use another set of artificial intelligence models to perform calculating.

In one preferred example of this embodiment, the financial future correlation prediction generating unit 160 can generate financial future correlation prediction among a plurality of requested financial instruments.

In one preferred example of this embodiment, the financial future correlation prediction from the financial future correlation prediction generating unit 160 can be transferred to another calculating unit, not shown in the figure, for producing optimized investment portfolio suggestion.

Another preferred embodiment according to this specification discloses a financial correlation prediction method. The mentioned financial correlation prediction method is for a financial correlation prediction system. There are many variable factors in individual financial instrument. If directly employing individual financial instrument to generate future correlation prediction, because of too many variable factors therein, the mentioned future correlation prediction is going to lose the accuracy. However, comparing with the individual financial instrument, the variability of market indicator is smaller. In this embodiment, we choose the future correlation prediction between individual financial instrument and market indicator is generated firstly, and the future correlation prediction between individual financial instruments can be obtained through calculating the mentioned future correlation prediction between individual financial instrument and market indicator. That is, the accuracy of the result of the financial correlation prediction method of this embodiment can be efficiently improved.

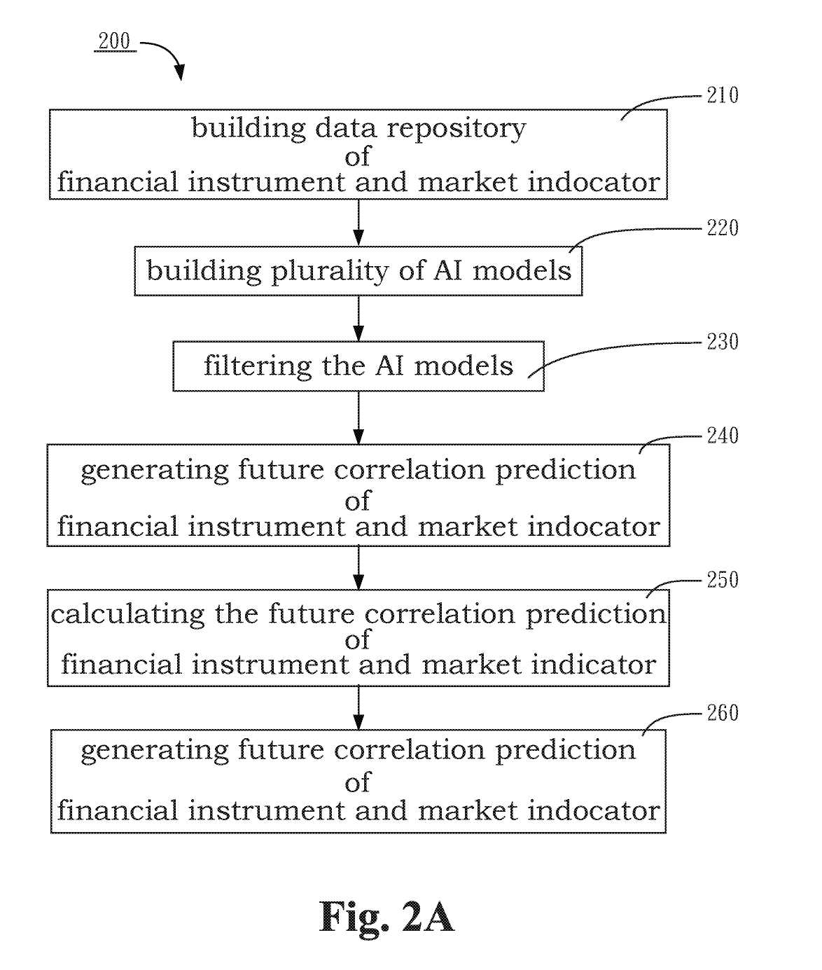

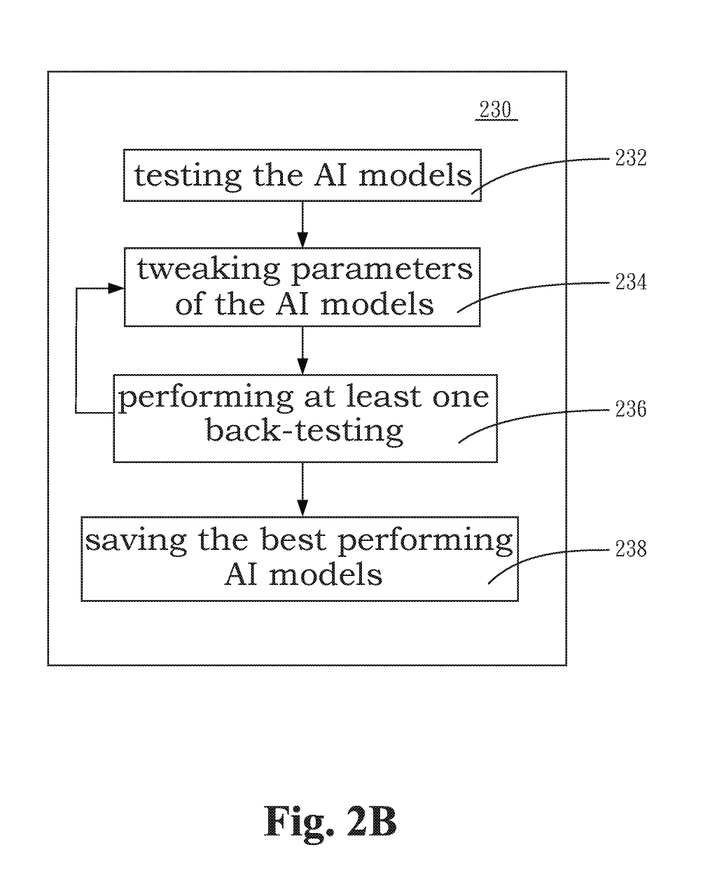

FIG. 2A shows a financial correlation prediction method of this embodiment for generating the financial correlation prediction between target financial instruments. The mentioned financial correlation prediction method 200 comprises step 210 of building data repository of financial instrument and related market indicator, step 220 of building a plurality of artificial intelligence (AI) models, step 230 of filtering the artificial intelligence models, step 240 of generating future correlation predictions between the financial instrument and the market indicator, step 250 of calculating the mentioned future correlation predictions, and step 260 of generating future correlation prediction between financial instruments.

In the steps 210, paired data from multiple data sources are collected separately for building a data repository of financial instrument and market indicator. The mentioned paired data is the paired data of financial instruments and market indicators. In one preferred example of this embodiment, the mentioned financial instrument can be stock, bond, currency, Futures, or other financial goods known by the one skilled in the art. The mentioned market indicator can be Dow Jones Industrial Average, S&P 500 Index, Nasdaq Composite Index, MSCI Emerging Markets Index, SSE Composite Index, Bond Index, US Dollar Index, Currency Exchange Rate, Futures Index, Market Sentiment Indicator, Inventor Sentiment Indicator, Purchase Management Index, Gross Domestic Product Index, or other financial indicators known by the one skilled in the art. In one preferred example of this embodiment, the data sources are selected from one or the combination of the group consisted of: sentiment indicators, adjusted historical data, fundamental data, macro data, live feeds, financial reports, social media data, and satellite images. Each of these paired data in the data categories should be maintained up to date, and clear of different types of biases. In one preferred example of this embodiment, the relational databases could be used for storage at the data repository. According to this embodiment, the paired data in the data repository is processed into a unified format to be used for training. And, the features of the paired data are extracted and saved in the mentioned data repository in the step 210.

In the step 220, the features of the paired data in the data repository are employed for building a plurality of artificial intelligence models. In one preferred example of this embodiment, one feature of the paired data in the data repository of financial instrument and related market indicator can be used for building the mentioned artificial intelligence models in the step 220. In another preferred example of this embodiment, multiple features of the paired data in the data repository of financial instrument and related market indicator can be used for building the mentioned artificial intelligence models in the step 220. The mentioned artificial intelligence models can be constructed from one of the group consisted of: RNN (recurrent neural networks), LSTM (long-short term memory), feed forward network, CNN (convolutional neural networks), and other artificial neural networks known by the one skilled in the art. In one preferred example of this embodiment, the mentioned features are selected from one or the combination of the group consisted of: price movements, covariances, and product characteristics. In one preferred example of this embodiment, the output of the mentioned artificial intelligence models can be a time series of observations. In one preferred example of this embodiment, the output of the artificial intelligence models can be sliced into training, validation, and testing data for the artificial intelligence models. The mentioned artificial intelligence models can be trained in the mentioned step 220. In one preferred example of this embodiment, the mentioned artificial intelligence models can be trained with the paired data with unified format from the step 210. The mentioned artificial intelligence models can be trained by the methodologies selected from at least one of the group consisted of: Adam Optimization Algorithm, back propagation, and other techniques/methodologies known by the one skilled in the art.

After building the artificial intelligence models in the step 220, the mentioned artificial intelligence models can be filtered in the step 230. According to this embodiment, the step 230 comprises the following steps: step 232 of testing the mentioned artificial intelligence models, step 234 of tweaking parameters of each of the artificial intelligence models, step 36 of performing at least one back-testing on the artificial intelligence models, and step 238 of saving the best performing models of the artificial intelligence models, as shown in FIG. 2B. In the step 232 of testing the mentioned artificial intelligence models, the mentioned artificial intelligence models are tested with multiple techniques and methodologies. In one preferred example of this embodiment, “new historical paired data” in new time period can be used for testing the artificial intelligence models in the mentioned testing, wherein the “new historical paired data” is the paired data in new time period, and is different from those paired data employed for building the artificial intelligence models. After the step 232 of testing the mentioned artificial intelligence models, those artificial intelligence models generating worst testing data in the testing are filtered out and deleted. In one preferred example of this embodiment, the mentioned artificial intelligence models generating worst testing data means the deviation of the testing results of the artificial intelligence models and the paired data used in the testing is larger than a default value. After the step 232, parameter tweaking is performed on the plurality of artificial intelligence models past the mentioned testing in the step 234. The parameters of those artificial intelligence models past the mentioned testing are tweaked according to the testing results of those artificial intelligence models past the mentioned testing. In one preferred example of this embodiment, the step 234 further comprises hyper parameter adjusting, if necessary, wherein the hyper parameters of those artificial intelligence models past the mentioned testing are adjusted according to the mentioned testing result of those artificial intelligence models past the mentioned testing in order to yield better accuracy in the testing results. In the step 234, tweaking parameters/and adjusting hyper parameters is/are performed to those artificial intelligence models past the mentioned testing for obtaining a plurality of artificial intelligence models past parameter tweaking.

Subsequently, in the step 236 of performing at least one back-testing, the plurality of artificial intelligence models past parameter tweaking are performed at least one beck-testing with another batch of “new historical paired data”. After every back-testing, the artificial intelligence models past parameter tweaking generating worst testing data in the back-testing are filtered out and deleted. In one preferred example of this embodiment, the mentioned artificial intelligence models past parameter tweaking generating worst testing data in the back-testing means the deviation of the testing results of the artificial intelligence models past parameter tweaking and the paired data (another batch of now historical paired data) used in the back-testing is larger than a default value. And at least one artificial intelligence models past the back-testing are performed another parameters tweaking/and hyper parameters adjusting respectively according to the back-testing result. In one preferred example of this embodiment, there can be a loop between the step 234 of tweaking parameters and the step 236 of performing back-testing. In the step 238 of saving the best performing artificial intelligence models, the at least one artificial intelligence models past the back-testing can be saved. In one preferred example of this embodiment, only recent at least one artificial intelligence models past the back-testing can be kept and saved in the step 238, and the earliest artificial intelligence models past the back-testing will be periodically removed.

In the step 240, the at least one artificial intelligence models past the back-testing saved in the step 238 can be reloaded and be used for generating correlation prediction between financial instrument and market indicator according to the input request. The mentioned correlation prediction between financial instrument and market indicator can be used to predict the correlation between the financial instrument and the market indicator in a period of time in the future. The mentioned correlation prediction can be correlative coefficient, covariance, or other format known by the one skilled in the art. In the step 250, the correlation prediction between financial instrument and market indicator from the step 240 can be used for calculating and generating future correlation prediction between financial instruments according to the input request. In the step 260, the future correlation prediction between financial instruments from the step 250 can be presented in the mode asked by user.

In one preferred example of this embodiment, another set of artificial financial models can be used in the step 250 for calculating correlation prediction between financial instrument and market indicator. In another preferred example of this embodiment, the mentioned another set of artificial financial models can be at least one artificial financial model past testing, at least one back-testing and parameter tweaking.

In one preferred example of this embodiment, in the step 250, the mentioned calculating correlation prediction between financial instrument and market indicator is performed in correlative coefficient, covariance, or other format known by the one skilled in the art. In one preferred example of this embodiment, the calculation in the step 250 can be as the following.

$$r = \frac{Σ ( x - \overline{x} ) ( y - \overline{y} )}{\sqrt{{Σ ( x - \overline{x} )}^{2} {Σ ( y - \overline{y} )}^{2}}}$$

In one preferred example of this embodiment, the step 260 can be used to present a plurality of future correlation prediction between financial instruments as request.

In one preferred example of this embodiment, the future correlation prediction between financial instruments in the step 260 can be performed another calculating, not shown in the figure, for producing optimized investment portfolio suggestion.

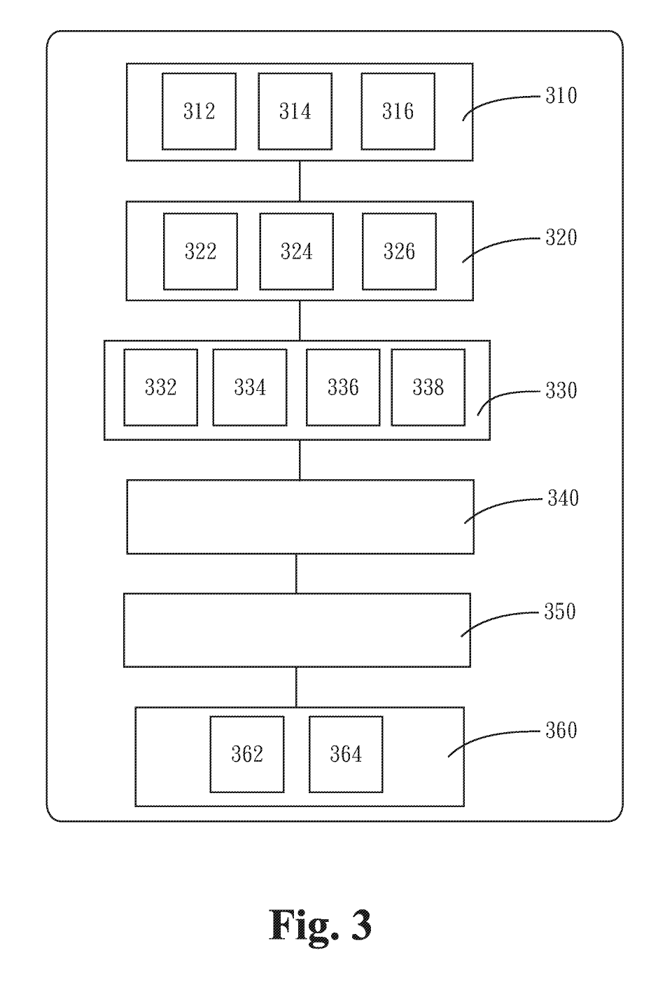

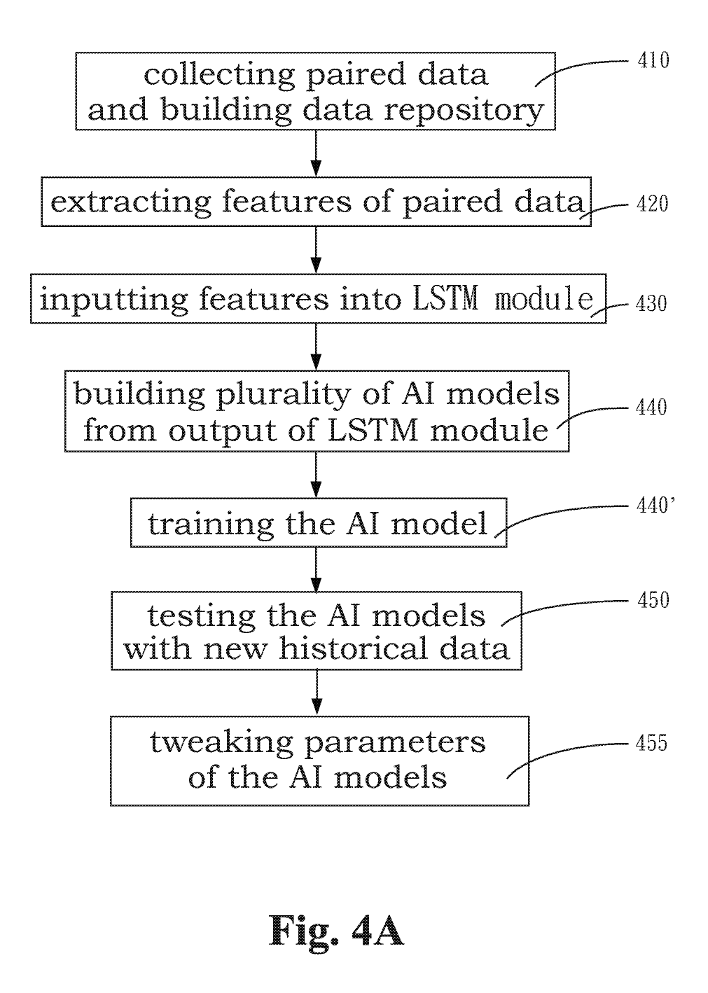

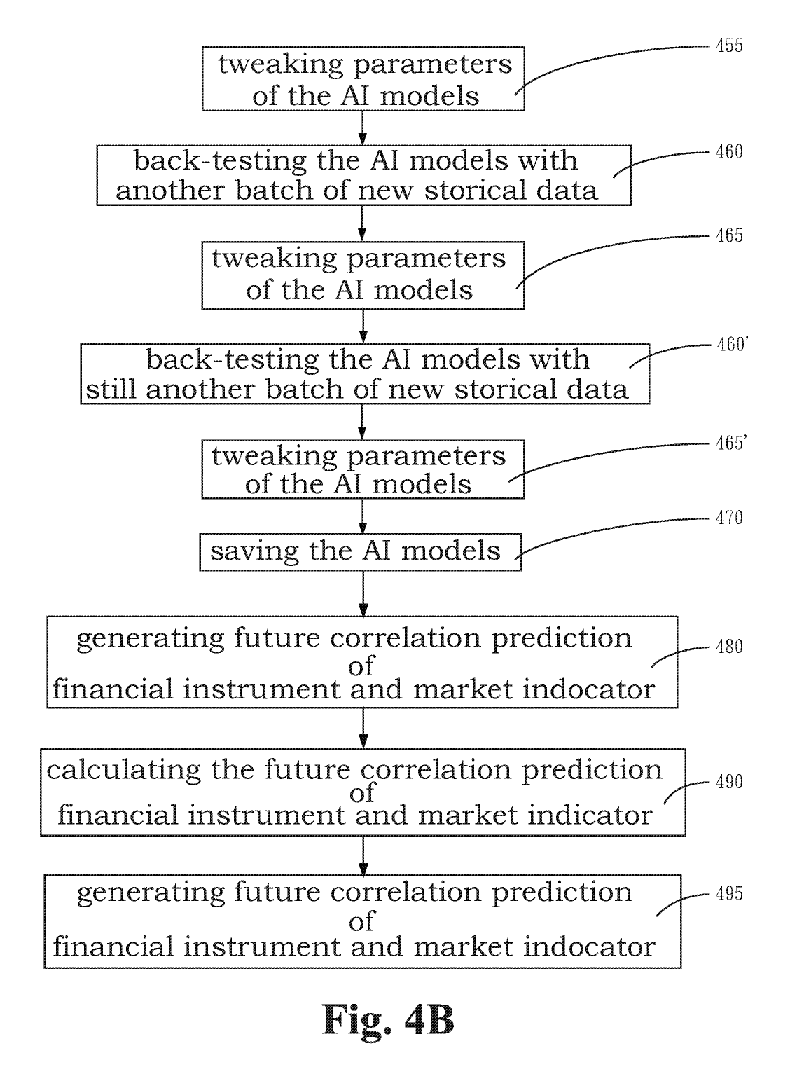

In still another embodiment according to this specification, a plurality of historical price data of financial instruments and market indicator of the financial instruments are used for generating the future correlation prediction of the financial instruments, as shown in FIG. 3 and FIGS. 4A to 4B. FIG. 3 shows a financial correlation prediction system of this example. FIGS. 4A and 4B show a flowchart of a financial correlation prediction method of this example. In this example, the market indicator is Nasdaq Composite Index, and the financial instruments are those financial instruments in Nasdaq Composite Index. It is noted that this example is not to limit the scope of this present invention, which should be determined in accordance with the Claims.

Firstly, the paired data collecting module 312 of the paired data importing unit 310 is used for individually collecting paired data constructed of the historical data of a plurality of financial instruments and the historical data of Nasdaq Composite Index. The collected paired data is used to build a data repository 314 in the paired data importing unit 310, as shown in the step 410. In one preferred example of this embodiment, the historical data of the financial instruments and Nasdaq Composite Index can be collected by user. In another preferred example of this embodiment, the historical data of the financial instruments and Nasdaq Composite Index can be collected by the paired data collecting module 312, wherein the paired data collecting module 312 can collect the mentioned paired data from internet automatically according to default condition. In this preferred example, the mentioned historical data of the financial instruments and Nasdaq Composite Index in the data repository 314 can be kept collecting and maintained up to date by the paired data collecting module 312. The paired data importing unit 310 is not only employed for collecting paired data constructed of the historical data of a plurality of financial instruments and the historical data of Nasdaq Composite Index, but also employed for extracting the features of the collected paired data by the feature extracting module 316 of the paired data importing unit 310. The mentioned paired data in the data repository 314 is processed into a unified form. The features extracted by the feature extracting module 316 can be saved in the data repository 314.

The features of the paired data is going to be transported to a long-short term memory module (hereinafter referred to as “LSTM module”) 322 of a model building unit 320. The features of the paired data can be used as input of the LSTM module 322, as shown in the step 430. The output of the LSTM module 322 can be used for building a plurality of artificial intelligence models (hereinafter referred to as “AI models”), as shown in the step 440. In one preferred example of this embodiment, the LSTM module 322 can be used for building multiple groups of a plurality of AI models. The AI models are sequentially performed training, back-testing, and generating prediction results. In order to simplify this embodiment, one feature of the paired data, the historical price data of financial instruments and Nasdaq Composite Index, is used for building the multiple groups of a plurality of AI models in the following.

Before testing, the mentioned AI models can be trained with Optimization Algorithm in optimizing module 324 to obtain trained AI models, as shown in the step 440′. According to this example, Adam Optimization Algorithm can be employed for training the AI models to obtain the trained AI models in the mentioned optimizing module 324. The mentioned trained AI models can be saved in a model saving module 326.

The mentioned trained AI models are transported to a model filtering unit 330. The mentioned trained AI models are performed testing and parameter tweaking in the model filtering unit 330 to obtain a plurality of AI models close to the correlation of the financial instruments and Nasdaq Composite Index. In the model filtering unit 330, the mentioned plurality of trained AI models are performed testing with “new paired data” in a model testing module 332, as shown in the step 450. In this embodiment, the mentioned “new paired data” can be paired data of financial instruments and Nasdaq Composite Index in new time period. In another example of this embodiment, the mentioned “new paired data” can be paired data of financial instruments and Nasdaq Composite Index in different time period, for example, paired data of financial instruments and Nasdaq Composite Index in larger time range than the time range of paired data used in model building unit 320. In the mentioned testing, if the deviation of the testing results of the AI models and the “new paired data” in the testing is larger than a default value, these AI models will be not past the testing because of the mentioned deviation of the testing results of these AI models. And, these AI models not past the testing will be filtered out and deleted. The plurality of AI models past the mentioned testing will be kept. The plurality of AI models past the mentioned testing will be performed parameter tweaking/and hyper parameter adjusting in a parameter tweaking module 334 in the model filtering unit 330, according to the deviation of the testing results of each of the mentioned plurality of AI models in the testing, for obtaining a plurality of AI models past parameter tweaking, as shown in the step 455.

The mentioned plurality of AI models past parameter tweaking will be transported to a back-testing module 336 in the model filtering unit 330. The AI models past parameter tweaking will be performed back-testing with “another batch of new paired data” in the back-testing module 336, as shown in the step 460. Similarly, in the back-testing module 336, if the deviation of the back-testing results of the AI models and the “another new paired data” in the back-testing is larger than a default value, these AI models will be not past the back-testing and be deleted because of the mentioned deviation of the back-testing results of these AI models. The at least one AI model past the back-testing will be kept, and be performed parameter tweaking/and hyper parameter adjusting in the parameter tweaking module 334, according to the deviation of the back-testing results of each of the mentioned at least one AI model in the back-testing, for obtaining a plurality of AI models past parameter tweaking, as shown in the step 465. The mentioned AI models past parameter tweaking can be performed second time back-testing with “another batch of paired data” in the back-testing module 336, as shown in the step 460′. Those AI models not past the mentioned second time back-testing will be deleted. The at least one AI model past the second time back-testing will be performed parameter tweaking/and hyper parameter adjusting in the parameter tweaking module 334, according to the testing results of each of the mentioned at least one AI model in the second time back-testing, for obtaining a plurality of AI models past second time parameter tweaking, as shown in the step 465′. The mentioned AI models past second time parameter tweaking can be saved in a best model saving module 338, as shown in the step 470. In order to simplify the illustration of the model filtering unit 330, there are two times of back-testing performed in this embodiment. In real operation, there can be many times of back-testing performed in the model filtering unit 330, according to the setting by user, for obtaining a plurality of AI models more close to the correlation of the financial instruments and the Nasdaq Composite Index.

According to this embodiment, in the future correlation prediction unit 340, the mentioned plurality of AI models past the second time parameter tweaking are used to generate the future correlation predictions of individual financial instruments and the Nasdaq Composite Index, according to the request of the length of time from a input interface 362 in the financial future correlation prediction generating unit 360, as shown in the step 480. The mentioned input interface 362 can be keyboard, pointing device, graphical user interface, or other device known by the one skilled in this art. The request from the input interface 362 can be length of time, financial instrument item, weighted ratio, threshold value, or other factor known by the one skilled in this art. The plurality of future correlation predictions of individual financial instruments and the Nasdaq Composite Index generated in the future correlation prediction unit 340 can be transported to the calculating unit 350. The mentioned future correlation predictions of individual financial instruments and the Nasdaq Composite Index are performed calculating in the calculating unit 350, according to the request from the input interface 362, for generating a plurality of financial future correlation predictions of financial instruments, as shown in the step 490. The mentioned financial future correlation predictions of financial instruments can be transported to the output interface 364 in the financial future correlation prediction generating unit 360. The mentioned financial future correlation predictions of financial instruments can be displayed on the output interface 364 as the form requested by user, as shown in the step 495. The output interface 364 can be a displayer. In one preferred example of this embodiment, the mentioned financial future correlation predictions can be displayed as graphic mode, string mode, or other form known by the one skilled in this art.

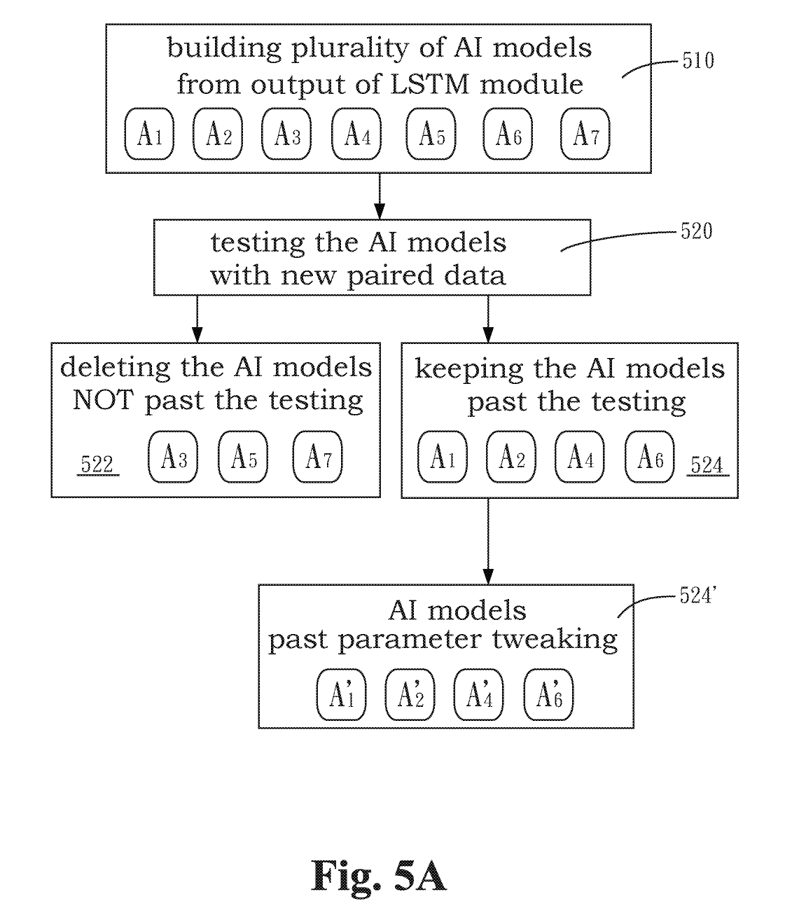

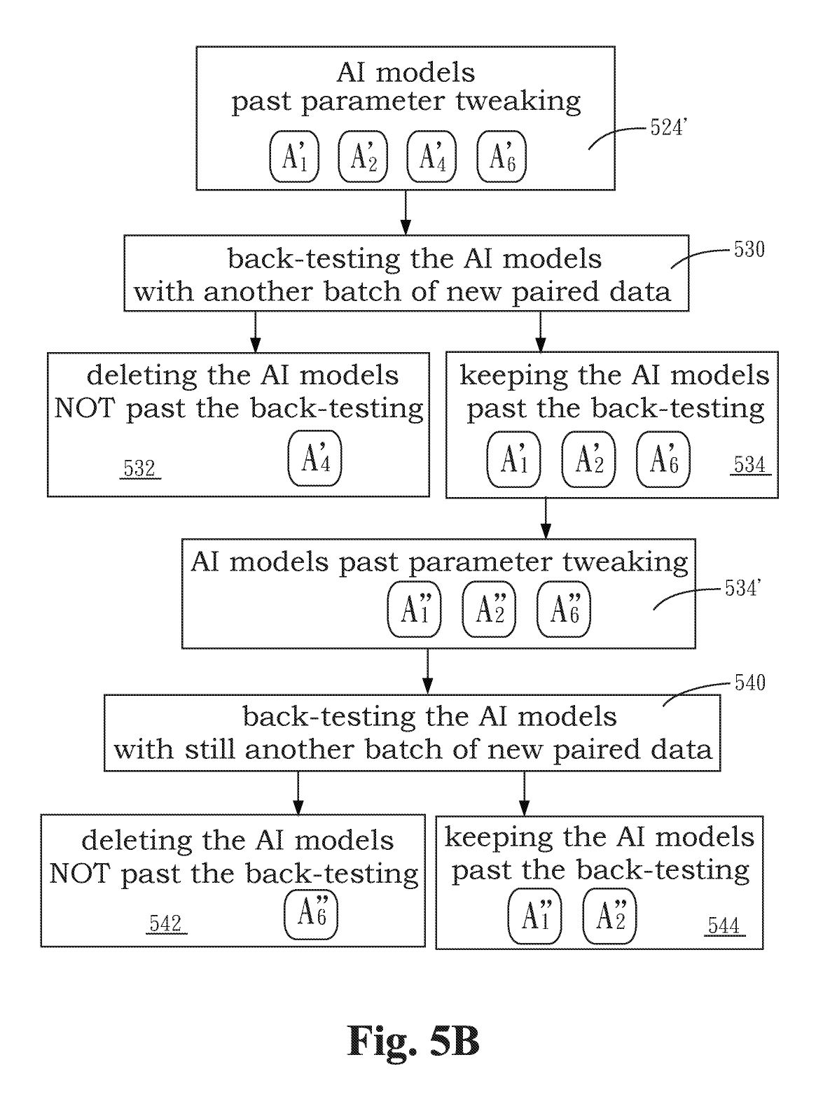

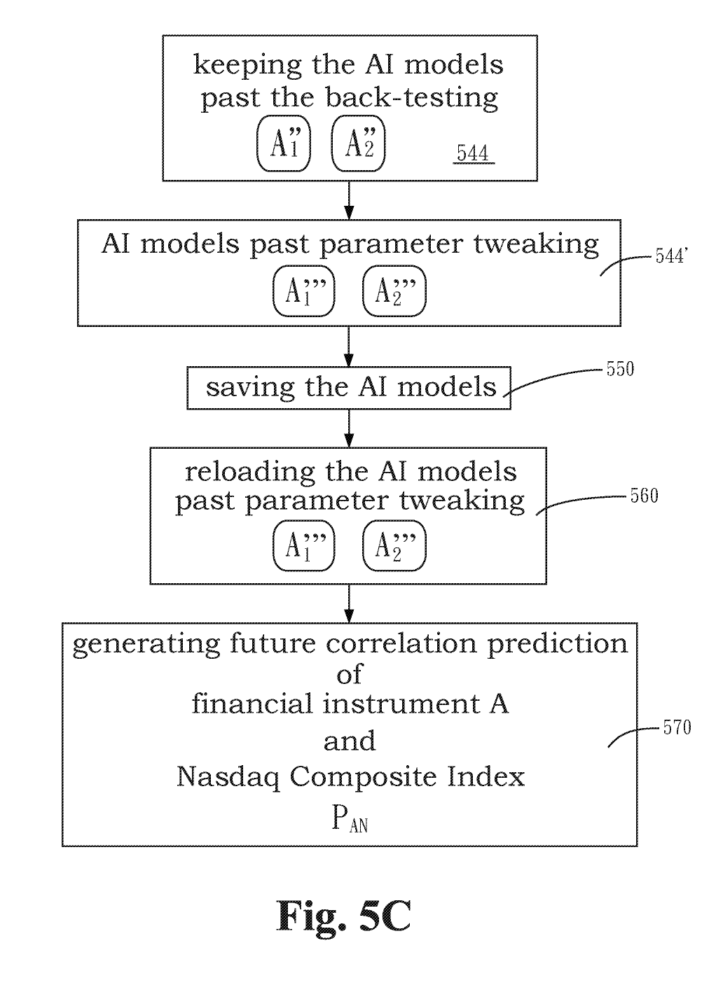

In one preferred example of this embodiment, FIGS. 5A and 5B can be used for further explaining the process of how to generate future correlation prediction of the financial instrument A and Nasdaq Composite Index as in FIGS. 4A and 4B. It should be noticed that the amount and variety of AI models in this example are not to limit the scope of this present specification.

Please referred to FIG. 3, FIGS. 5A and 5B, after inputting the features of the paired data of the historical price data of the financial instrument A and Nasdaq Composite Index to the LSTM module 322, the output of the LSTM nodule 322 can be used to build the AI models A₁, A₂, A₃, A₄, A₅, A₁₆, A₇, as shown in the step 510 in FIG. 5A. The mentioned AI models are trained with Optimization Algorithm in the optimizing module 324 in FIG. 3, not shown in FIG. 5A. The mentioned AI models can be transported to the model testing module 332 in FIG. 3, and performed testing with the “new paired data” in the model testing module 332, as shown in the step 520 in FIG. 5A. In the model testing module 332, those AI models not past the testing will be deleted, such as the AI models A₃, A₅ and A₇ shown in the step 522 in FIG. 5A. The AI models past the testing, such as the AI models A₁, A₂, A₄ and A₆ shown in the step 524 in FIG. 5A, will be kept and transported to the parameter tweaking module 334 in FIG. 3. In the parameter tweaking module 334, every AI model past the testing will be performed parameter tweaking/and hyper parameter adjusting individually, according to the deviation of the testing result of the AI model and the “new paired data” in the testing, for obtaining the AI models past parameter tweaking, as the AI models A₁′, A₂′, A₄′ and A₆′ shown in the step 524′ in FIG. 5A.

The mentioned AI models past parameter tweaking will be transported to the back-testing module 336 shown in FIG. 3, and will be performed back-testing with “another batch of new paired data”, as shown in the step 530 in FIG. 5B. In the back-testing module 336, those AI models not past the back-testing, such as the AI models A₄′ shown in the step 532 in FIG. 5B, will be deleted. The AI models past the back-testing, such as the AI models A₁′, A₂′ and A₆′ shown in the step 532 in FIG. 5B, will be kept, and will be transported to the parameter tweaking module 334 shown in FIG. 3. In the parameter tweaking module 334, every AI models past the back-testing will performed parameter tweaking/and hyper parameter adjusting individually, according to the deviation of the back-testing result of the AI model and the “another batch of new paired data” in the back-testing, for obtaining the AI models past parameter tweaking, such as the AI models A₁″, A₂″ and A₆″ shown in the step 532 in FIG. 5B.

Those AI models past parameter tweaking, such as the AI models A₁″, A₂″ and A₆″, can be transported to the back-testing module 336 again, and be performed the second time back-testing with “still another batch of new paired data”, as shown in the step 540 in FIG. 5B. As mentioned above, those AI models not past the mentioned second time back-testing, such as the AI model A₆″, will be deleted, as shown in the step 542 in FIG. 5B. The AI models past the mentioned second time back-testing, such as the AI models A₁″ and A₂″, will be kept and be transported to the parameter tweaking module 334 shown in FIG. 3, as shown in the step 544 in FIG. 5B. In the parameter tweaking module 334, every AI models past the second time back-testing will performed parameter tweaking/and hyper parameter adjusting individually, according to the deviation of the second time back-testing result of the AI model and the “still another batch of new paired data” in the second time back-testing, for obtaining the AI models past parameter tweaking, such as the AI models A₁′″ and A₂′″ shown in the step 544 in FIG. 5B. According to the design of this specification, there can be many times of the loop between back-testing and parameter tweaking according to the setting by user for obtaining AI models closer to the correlation of the financial instrument A and Nasdaq Composite Index. In this example, in order to simplify the illustration, the AI models are only performed two times of the loop between back-testing and parameter tweaking. The mentioned AI models A₁′″ and A₂′″ past the parameter tweaking will be saved in the best model saving module 338 in FIG. 3, as shown in the step 550 in FIG. 5C. It also should be noted that when new AI models past the mentioned back-testing and parameter tweaking, the mentioned new AI models will be saved into the best model saving module 338, and the AI models earliest saved in the best model saving module 338 will be periodically removed from the best model saving module 338.

In this example, the AI models A₁′″ and A₂′″ saved in the best model saving module 338 can be reloaded in the future correlation prediction unit 340 in FIG. 3, as shown in the step 560 in FIG. 5C. The AI models A₁′″ and A₂′″ can be used for respectively generating the future correlation predictions P_{AN} of the financial instrument A and Nasdaq Composite Index, as shown in the step 570 in FIG. 5C, according to the request of the length of time from the input interface 362 in FIG. 3. Similarly, other financial instruments, such as financial instrument B and financial instrument C, also can be performed in the process as shown in FIGS. 5A and 5B for individually obtaining the future correlation predictions P_{BN} of the financial instrument B and Nasdaq Composite Index, and the future correlation predictions P_{CN} of the financial instrument C and Nasdaq Composite Index. The prediction results generated in the future correlation prediction unit 340, as the mentioned P_{AN}, P_{BN} and P_{CN}, can be transported to the calculating unit 350 in FIG. 3 for respectively calculating the future correlation prediction result of the financial instrument A and the financial instrument B, the future correlation prediction result of the financial instrument A and the financial instrument C, and the future correlation prediction result of the financial instrument B and the financial instrument C. in this example, correlation coefficient can be employed in the calculating unit 350 as assessment for the future correlation prediction results among the financial instruments A, B and C. The future correlation prediction results generated in the calculating unit 350 can be transported to the output interface 364 in FIG. 3, and be displayed on the output interface 364 as the form requested by user.

According to this example specification, comparing the mentioned financial correlation prediction system and the method thereof to current existing methodology, the advantage of the mentioned financial correlation prediction system and the method thereof includes:

1. Model architecture;

2. Differencing methods;

3. Output level adjustments;

4. Sequential learning;

5. Data and financial solution acquisition;

6. Hardware acquisition and cloud-based (AWS) computing environment cost;

7. Project management professional and administrative staff capable of project management, with sufficient financial background for data vender evaluation, software/cloud-based solution development monitoring and solution version evaluation;

8. Compensate project-based data scientist, researcher, etc.; and

9. Software developer (internal or external) for long-term.

The mentioned financial correlation prediction system and the method thereof can focus on three points as the following:

A. Individual asset risk forecasts and simulations that are deep learning-driven and does not rely on conventional Monte Carlo method.

B. Optimized portfolio weights that are based on forward forecasts as predicted by complex time series AI models.

C. Automatic and efficient back-testing for verification based on the new methodologies and various portfolio constructions to assist decision making.

In one example of this specification, the mentioned financial correlation prediction system can be used for inputting a plurality of features of each financial instrument into RNN to build a plurality of AI models with the output of the RNN. After the mentioned steps of model testing, parameter tweaking and back-testing, at least one best AI model is obtained. The mentioned at least one best AI model can be used for generating future correlation prediction of portfolio. So that, the mentioned financial correlation prediction system can be used to assist investment institution and investor controlling risk more efficiently.

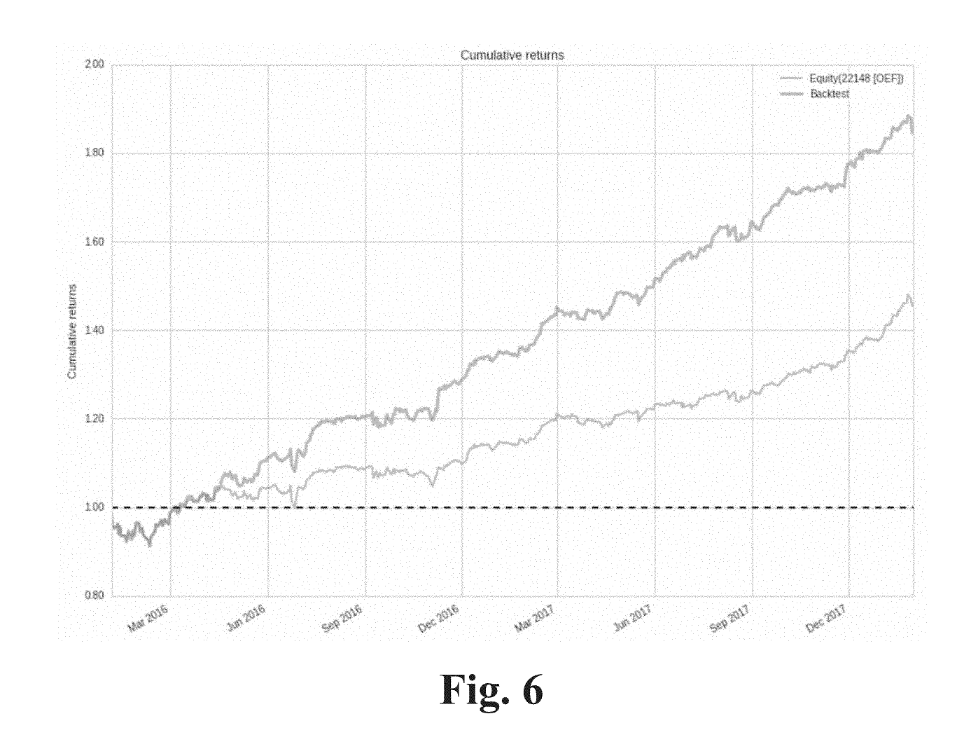

FIG. 6 shows a cumulative returns graph of a portfolio of the financial correlation prediction system of this specification and passive market benchmark/S&P500. The sampling time of FIG. 6 is from Jan. 6, 2016 to Jan. 31, 2018. The lower curve (the thinner line) in FIG. 6 shows the cumulative returns graph of passive market benchmark/S&P500 [Equity (22148[OEF]). The upper curve (the thicker line) in FIG. 6 shows the cumulative returns graph of the portfolio of the financial correlation prediction system of this specification. It can be found from FIG. 6 that the cumulative returns of the portfolio of the financial correlation prediction system is much better than the cumulative returns of passive market benchmark/S&P500 because of the accurate results to future financial correlation prediction of the financial instruments generated by the financial correlation prediction system of this present example.

Therefore, according to the disclosure of this specification, investment team of financial institute can focus on risk management. That is, this specification provides a solution for perfectly engaging portfolio optimization and future quantitative risk forecast.

According to the disclosure of this specification, the list development of the mentioned financial correlation prediction system and the method thereof includes the followings:

1. Identifying areas in the current Portfolio Construction/Risk Management that could be enhanced using Machine Learning;

2. Forging the methodology and potential theoretical solution to identified weak areas;

3. Constructing the required data infrastructure to support the machine learning development;

4. Developing the AI models and training them using the data provided;

5. Backtest the models using generated outputs against historical data;

6. Build the infrastructure to automate data management, model training, output generation and output storage; and

7. Developing “client” interfaces to load and present the outputs from the models (GUI, Rest API).

In summary, we have reported a financial correlation prediction system and the method thereof. The mentioned financial correlation prediction system and the method can uses multi-layer perception (deep neural network) and artificial neural network (ANN) model structure to generate more accurate forward correlation predictions of financial instruments. The mentioned financial correlation prediction system and the method thereof comprises collecting paired data of financial instrument and related market indicator and building data repository of the paired data with paired data importing unit, building and training a plurality of artificial intelligence models with model importing unit, filtering the artificial intelligence models with model filtering unit, tweaking parameters of the artificial intelligence models past testing/back-testing with parameter tweaking module, and saving the best artificial intelligence models in model saving module. The mentioned best artificial intelligence models are past parameter tweaking, and are closest to the trend of the financial instrument. The mentioned saved artificial intelligence models can be used for generating future correlation prediction of financial instrument and related market indicator with future correlation prediction generating unit. The mentioned future correlation prediction of financial instrument and related market indicator can be used for calculating for generating the future correlation prediction of financial instruments with calculating unit. According to this specification, future correlation predictions among competitive financial instruments can used to build portfolios which consider increasing/decreasing correlations among financial instruments and construct a more effective portfolio.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

1. A financial correlation prediction system, comprising:
paired data importing unit, wherein said data importing unit comprises a data collecting module, a data repository, and a paired data feature extracting module, wherein said data collecting module is used for collecting a plurality of paired data of financial instrument and market indicator, and the paired data collected by said data collecting module is saved in said data repository, wherein said feature extracting module is used for extracting features of the paired data collected by said data collecting module and for saving the features in said data repository, wherein said financial instrument is related to said market indicator;
model building unit, wherein said model building unit comprises a neural network module and a model saving module, wherein the features extracted by said feature extracting module are used as input of said neural network module, wherein output of said neural network module is used to build a plurality of artificial intelligence models, wherein the plurality of artificial models are saved in said model saving module;
model filtering unit, wherein said model filtering unit comprises a model testing module, a parameter tweaking module, a back-testing module, and a best model saving module, wherein said model testing module is used for testing the plurality of artificial intelligence models, wherein said parameter tweaking module is used for tweaking parameters of a plurality of artificial intelligence models past the testing of said model testing module based on testing results generated by the plurality of artificial intelligence models in the testing for obtaining a plurality of artificial intelligence models with tweaked parameter, wherein the plurality of artificial intelligence models with tweaked parameter obtained in said parameter tweaking module is performed at least one back-testing by said back-testing module, wherein after every back-testing, a plurality of artificial intelligence models past the back-testing are performed parameter tweaking by said parameter tweaking module based on back-testing results generated by the plurality of artificial intelligence models in the back-testing for obtaining at least one artificial intelligence model past back-testing and parameter tweaking, wherein the at least one artificial intelligence model past back-testing and parameter tweaking is saved in said best model saving module;
future correlation prediction generating unit, wherein the at least one artificial intelligence model past back-testing and parameter tweaking is reloaded in said future correlation prediction generating unit for generating future correlation prediction between financial instrument and market indicator;
calculating unit, wherein said calculating unit is used for calculating the future correlation prediction between financial instrument and market indicator from said future correlation prediction generating unit for generating future correlation prediction between financial instruments; and
financial correlation prediction generating unit, wherein said financial correlation prediction generating unit comprises an inputting interface and an outputting interface, wherein said inputting interface is used to input financial correlation prediction request of financial instruments into said calculating unit, wherein the future correlation prediction result of those financial instruments is displayed by said outputting interface.

2. The financial correlation prediction system according to claim 1, wherein said model building unit further comprises an optimizing module, wherein said optimizing module is used for optimizing the plurality of artificial models before the plurality of artificial models is saved in said saving module.

3. The financial correlation prediction system according to claim 1, wherein said neural network module is recurrent neural networks (RNN).

4. The financial correlation prediction system according to claim 1, wherein said neural network module is long-short term memory (LSTM).

5. The financial correlation prediction system according to claim 1, wherein said calculating unit uses correlative coefficient or covariance on calculating the future correlation prediction between financial instrument and market indicator.

6. A financial correlation prediction method, wherein said financial correlation prediction method is used for a financial correlation prediction system, comprising:
collecting a plurality of paired data of financial instrument and market indicator for building a data repository, wherein the paired data saved in the data repository is collected and maintained up to date by a paired data collecting module, wherein features of the paired data are extracted by a feature extracting module and are saved in the data repository;
building a plurality of artificial intelligence models, wherein the features of the paired data are employed as input of a neural network module, and output of the neural network module is used to build said plurality of artificial intelligence models;
filtering the plurality of artificial intelligence models, wherein the plurality of artificial intelligence models is performed a testing by a model testing module for producing at least one artificial intelligence model past the testing, wherein the at least one artificial intelligence model past the testing is performed parameter tweaking based on testing result of the at least one artificial intelligence model past the testing by a parameter tweaking module for producing at least one artificial intelligence model with tweaked parameter, wherein the at least one artificial intelligence model with tweaked parameter is performed at least one back-testing for producing at least one artificial intelligence model past the back-testing, wherein at least one artificial intelligence model past the back-testing, after every back-testing, is performed parameter tweaking based on back-testing result of the at least one artificial intelligence model past the back-test by the parameter tweaking module for producing at least one best artificial intelligence model, wherein the at least one best artificial intelligence model is saved in a best model saving module;
generating future correlation prediction between financial instrument and market indicator, wherein the at least one of the best artificial intelligence model is reloaded for generating the future correlation prediction between financial instrument and market indicator;
calculating future correlation prediction between financial instruments, wherein the future correlation prediction between financial instrument and market indicator is used for calculating the future correlation prediction between financial instruments; and
generating future correlation prediction between financial instruments, wherein the future correlation prediction between financial instruments in the step of calculating future correlation prediction between financial instruments is displayed by an outputting interface.

7. The financial correlation prediction method according to claim 6, wherein the neural network module is recurrent neural networks (RNN).

8. The financial correlation prediction method according to claim 6, wherein the neural network module is long-short term memory (LSTM).

9. The financial correlation prediction method according to claim 6, wherein coefficient or covariance on calculating is used for calculating the future correlation prediction between financial instruments.
